(19) United States
(12) Patent Application Publication
(10) Pub. No.: US 2005/0051988 A1
(43) Pub. Date: Mar. 10, 2005

(54) Active toe control system and method for an automotive vehicle

(76) Inventors: Mircea Gradu, Wooster, OH (US); Timothy L. Schlernitzauer, Canton, OH (US); Carl W. Davenport, New Hartford, CT (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/931,551

(22) Filed: Sep. 1, 2004

Related U.S. Application Data
(60) Provisional application No. 60/501,627, filed on Sep. 9, 2003.

(51) Int. Cl. B60G 3/04

(52) U.S. Cl. 280/124.134

(57) ABSTRACT

The present invention relates to an active toe control system for an automotive vehicle where the system includes a control arm or link that is axially adjustable to either shorten or lengthen the length of the control arm or link. The control arm includes an electric motor connected between the connecting points of the control arm or link, the electric motor being responsive to an electronic control unit that communicates signals the electric motor to control the rotation of the electric motor and the duration of time the electric motor is operated. The combination of components acts to actively adjust the toe of the wheels of an automotive vehicle.

### CROSS-REFERENCE TO RELATED APPLICATIONS

This application claims priority to provisional application Ser. No. 60/501,627 filed on Sep. 9, 2003.

### STATEMENT REGARDING FEDERALLY SPONSORED RESEARCH OR DEVELOPMENT

Not Applicable.

### BACKGROUND OF THE INVENTION

Varying the toe angle of the rear wheels on an automotive vehicle during the operation of the vehicle improves the vehicle's handling and maneuverability. The following rear wheel reactions result in better vehicle dynamics under the respective operating conditions:
a. braking or deceleration: toe-in
b. acceleration: toe-in
c. cornering: initial toe-out of the outer wheel that changes to toe-in at a lateral force of 0.4 to 0.5 g.
   An optimized rear wheel alignment can also impact favorably the vehicle fuel efficiency, by minimizing the drag and spin on the rear tires.

Two major approaches have been used:
(1) to actively orient the wheels by an input from the car's steering wheel; and
(2) to let road forces and suspension geometry realign the toe and camber angles as generally shown in U.S. Pat. No. 4,740,012. The first approach can be called an active design, and the second is called a passive design. Both of these systems add more moving parts, complexity, weight and cost to the rear suspension.

The present invention involves an Active Toe Control System that is a cost effective and efficient alternative to the two previous approaches as described above.

### BRIEF DESCRIPTION OF THE SEVERAL VIEWS OF THE DRAWINGS

In the drawings, wherein like numerals and letters refer to like parts wherever they occur.

FIG. 1 is a perspective view of a standard rear suspension system for an automotive vehicle;

FIG. 2 is section view of one embodiment of the present invention; and

FIG. 3 is section view of another embodiment of the present invention.

Corresponding reference characters indicate corresponding parts throughout the several views of the drawings.

While one embodiment of the present invention is illustrated in the above referenced drawings and in the following description, it is understood that the embodiment shown is merely for purpose of illustration and that various changes in construction may be resorted to in the course of manufacture in order that the present invention may be utilized to the best advantage according to circumstances which may arise, without in any way departing from the spirit and intention of the present invention, which is to be limited only in accordance with the claims contained herein.

### DETAILED DESCRIPTION

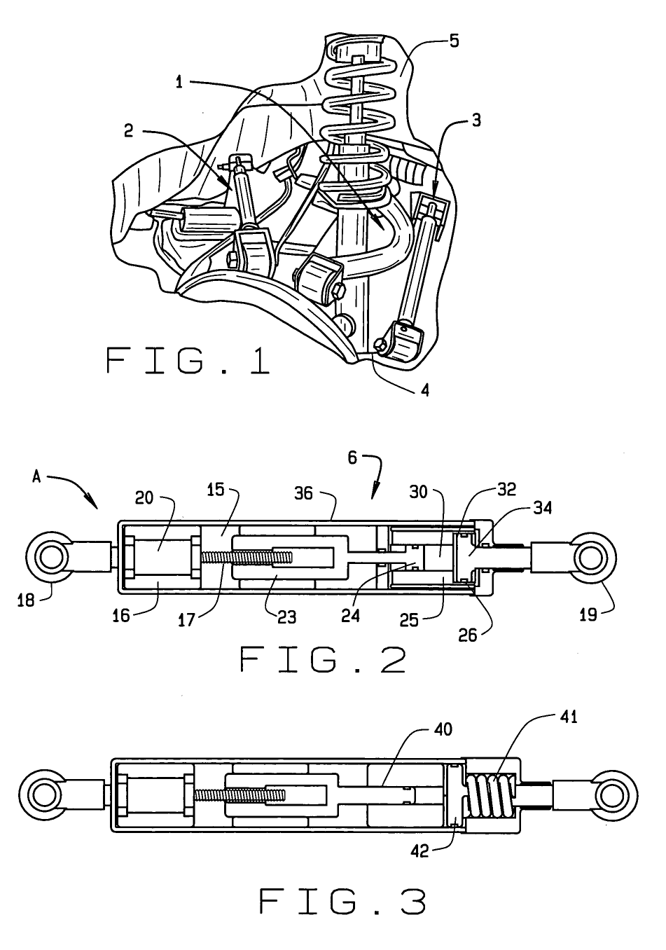

As shown in FIG. 1, the majority of the current rear suspension designs include means for manually adjusting the length of a trailing arm or control arm for the rear wheel suspension in order to modify the toe angle of the corresponding wheel. That configuration includes a rear upper arm 1, a forward link 2, and a toe link 3, both of which are connected to the spindle assemblies 4 of each of the two rear wheels on an automotive vehicle 5.

Referring to FIG. 2, the present invention of an active toe control system A resides in a control arm or link 6, usually in a trailing position, with a built-in linear actuator that can meet the travel, force, response time and packaging requirements to realize a continuously variable toe angle that can address specifically the various vehicle-operating conditions to obtain significant benefits related to safety, handling and fuel-efficiency. The control arm or link 6 has a continuously adjustable length that can be used to directly replace an existing control arm or link such as the toe link 3 of FIG. 1, without other modifications of the rear suspension design. The optimum toe angle is achieved by relying on the suspension compliance.

An electronic control unit 10 (not shown) receives and processes the signals from a wide variety of sensors placed in the automotive vehicle 5 (FIG. 1). For example, one group of typical sensors would include a yaw sensor, a wheel speed sensor, a lateral acceleration sensor, a longitudinal acceleration sensor, and a steering angle sensor. It is appreciated that other sensors may also be included depending upon the application. The electronic control unit 10 makes the final decision on the modifications to be made to the overall length of the control arm or link 6 modifications resulting to make the any necessary adjustments to the toe angle.

FIG. 2 also shows a cross section of one embodiment of the present invention. In FIG. 2, the control arm or link 6 contains an integrated linear actuator 15 comprising an electric motor 16, a ball screw or trapezoidal screw mechanism 17, and a hydraulic system 18 that reduces the axial travel between the connecting points 18 and 19 while amplifying the axial force within the control arm or link 6. The rotor 20 of the electric motor 16 is integral with the screw mechanism 17 that controls the axial displacement of the nut 23 and integrated small piston 24 of the small cylinder 25. The small piston 24 pushes a fluid into the small cylinder 25 and transmits the axial displacement of the small piston 24 to the large cylinder 26 that is connected to the connecting point 19 that is itself connected to the joint of the suspension arm (not shown) on the automotive vehicle 5.

The ratio between the axial displacement of the small cylinder 25 and the axial displacement of the large cylinder 26, controls the ratio between the axial force applied on the small cylinder 25 and the axial cross-sections. Together, the small cylinder 25 and the large cylinder 26 act as a hydraulic system to function as a force amplifier and displacement reducer, thereby replacing the more costly and less reliable planetary gear mechanisms used as torque amplifiers/speed reducers in some linear actuator designs.

In order to reduce the length of the control arm or link 6, the rotor 20 of the electric motor 16 rotates the screw mechanism 17 to retract the small piston 24 by drawing the nut 23 toward the electric motor 21. This action will push the fluid 30 behind the small piston 24 of the small cylinder 25 to the cavity 32 behind the large piston 34 of the large cylinder 26, through the channels 33 situated between the actuator housing 36 and the outer diameter of the actuator housing cylinder 36 in which the pistons 24 and 34 operate.

An alternative design of the present invention is presented in FIG. 4. Here, the arm length reduction is realized just by retracting the small cylinder 40 and using a spring 41 behind the large piston 42 to provide additional axial force. All other components and operation of the embodiment of FIG. 4 are generally the same as the embodiment shown in FIG. 3.

In yet another embodiment of the invention, the hydraulic force/displacement generated by the small piston 24 is sufficient and the large piston 34 can be eliminated, provided that an electric motor 21 with the sufficient required torque capacity and rotary positioning capability is used.

While the above description describes various embodiments of the present invention, it will be clear that the present invention may be otherwise easily adapted to fit any configuration where an active toe control system for an automotive vehicle is required. As various changes could be made in the above constructions without departing from the scope of the invention, it is intended that all matter contained in the above description or shown in the accompanying drawings shall be interpreted as illustrative and not in a limiting sense.

1. In the rear suspension of an automotive vehicle, a control arm for actively varying to the angle of a rear wheel of the vehicle, said control arm comprising:
connecting ends configured to be coupled to a component of the suspension and to a nearby component fixed with respect to the body of the vehicle; and
an electric motor located between the ends and coupled with the connecting ends such that it can vary the spacing between the ends.

2. The combination according to claim 1 further comprising:
a housing in which the motor is located and to which one of the connecting ends is attached;
a screw located in the housing and driven by the motor;
a nut located in the housing and engaged with the screw, so that rotation of the screw drives the nut axially in the housing;
small and large cylinders in the housing where they are in communication;
a small piston located in the small cylinder and coupled with the nut; and
a large piston in the large cylinder and coupled with the other connecting end.

3. An active toe control system for an automotive vehicle comprising:
a control arm having an axial length that can be adjusted; and
an electronic control unit capable of communicating with the control arm
using a control signal communicated to the control arm, the electronic control unit being responsive to at least one signal communicated to the electronic control unit by at least one sensor.

4. The active toe control system of claim 3 wherein the control arm includes an integrated linear actuator comprising an electric motor, one of either a ball screw mechanism or a trapezoidal screw mechanism, and a hydraulic system that reduces the axial travel between a first connecting point on a proximate end of the control arm and a second connecting point on a distal end of the control arm, the hydraulic system being capable of amplifying the axial force within the control arm.

5. The active toe control system of claim 4 wherein the length of the control arm is adjusted by the control signal communicated from the electronic control unit to the electric motor to thereby control the toe-in or toe-out of a wheel on an automotive vehicle.

6. The active toe control system of claim 5 wherein the hydraulic system includes a small fluid control cylinder and large fluid control cylinder.

7. The active toe control system of claim 6 wherein the large fluid control cylinder acts to amplify the force of the small fluid control cylinder when a small piston in the small fluid control cylinder is axially relocated.

8. The active toe control system of claim 7 wherein the small piston of the small fluid control cylinder is axially adjusted by an electric motor having a rotor.

9. The active toe control system of claim 8 wherein the small piston of the small fluid control cylinder is connected to a nut.

10. The active toe control system of claim 9 wherein the nut is axially adjusted within the control arm by rotation of one of either the ball screw mechanism or the trapezoidal screw mechanism connected to the rotor of the electric motor such that the nut will move toward the electric motor when the rotor is rotated in a clockwise direction and where the nut will move away from the electric motor when the rotor is rotated in a counter clockwise direction.

11. The active toe control system of claim 10 wherein the direction of rotation of the electric motor and the time in which the electric motor is operated is controlled by the control signal communicated by the electronic control unit.

12. The active toe control system of claim 11 wherein the at least one sensor includes at least one of either a yaw sensor, a wheel speed sensor, a lateral acceleration sensor, a longitudinal acceleration sensor, and a steering angle sensor.

13. An active toe control system for an automotive vehicle comprising:
a control arm having an axial length that can be adjusted; and
means for automatically adjusting the axial length of the control arm in response to at least one signal communicated by at least one sensor.

14. A process of actively controlling the toe-in or toe-out of an automotive vehicle comprising the steps of:
installing an automatically adjustable control arm onto the suspension system of an automotive vehicle;
changing the length of the automatically adjustable control arm in response to at least one sensor that provides a signal correlating to a specific condition related to the automotive vehicle; and
adjusting the toe of a wheel on the automotive vehicle by adjusting the length of the automatically adjustable control arm.

15. The process of claim 14 further comprising the step of using an integrated linear actuator inside the automatically adjustable control arm to adjust the length of the automatically adjustable control arm.

16. The process of claim 15 further comprising the step of using a hydraulic system within the integrated linear actuator to amplify the force within the control arm used to adjust the length of the control arm.

17. The process of claim 16 further comprising the step of using an electric motor to operate the hydraulic system within the integrated linear actuator.
